(19) United States
(12) Patent Application Publication
(10) Pub. No.: US 2008/0098463 A1
(43) Pub. Date: Apr. 24, 2008

(54) ACCESS CONTROL FOR A MOBILE SERVER IN A COMMUNICATION SYSTEM

(75) Inventor: Johan Wikman, Helsingfors (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/551,587

(22) Filed: Oct. 20, 2006

(51) Int. Cl. H04L 9/32; G06F 15/16; H04L 9/00; G06K 9/00; G06F 17/30; G06F 17/00; G06F 9/00; G06F 7/04; G06F 7/58; H03M 1/68; G06K 19/00; H04K 1/00; H04N 7/16

(52) U.S. Cl. 726/5; 726/6; 726/12; 726/27; 713/153

(57) ABSTRACT

A system for providing access control for an information server implemented by a mobile terminal includes a proxy gateway configured for receiving a set of control rules, the rules identifying one or more clients by respective telephone numbers associated therewith. The proxy gateway receives a client request across a network to access a resource of the information server, where the request reflects a network address of the proxy gateway, and an identity of the information server outside the network. The proxy gateway determines if the client is authorized to access the requested resource based upon a telephone number associated with the client and the set of control rules, the proxy gateway having received the telephone number associated with the client before the request. If the client is authorized, the proxy gateway sends the request to the information server based upon the identity of the information server reflected in the request.

### FIELD OF THE INVENTION

The present invention generally relates to systems and methods effectuating a mobile server and, more particularly, relates to systems and methods for providing access control for a mobile server.

### BACKGROUND OF THE INVENTION

The mobile communications industry has seen a virtual explosion of growth over the past decade. The mobile terminal itself has evolved from a simplistic device offering two-way voice communications to a device that offers rich content communication capability such as, for example, color pictures, audio, music, and video clips.

The catalyst for such rich content capability began with the Short Messaging Service (SMS), which is still widely used today. With SMS, users are able to transport limited types of content including text, ringing tones, and small monochrome bit map displays using a store and forward model. In particular, the SMS message is first received by a Short Messaging Service Center (SMSC), which acts as the store and forward unit. Once the recipient becomes able to receive the message, the SMSC delivers the message to the recipient without any intervention from the recipient. The Multimedia Message Service (MMS) adds to the SMS capability by facilitating the use of richer content types including image formats such as the Joint Photographic Experts Group (JPEG) and the Graphics Interchange Format (GIF) as well as audio, music, and video clips. MMS is used for rich content exchange between Web applications and mobile devices and between the Internet and mobile devices.

As the functional capabilities of the mobile terminal continue to develop, they will not only be able to download information from Web applications and the Internet, but the mobile terminal itself will become a source of information for other network components. In particular, the advanced mobile terminals available today are already capable of capturing images, creating video clips, and recording audio through the use of integrated camera and microphone resources within the mobile terminal itself. The capabilities of tomorrow's mobile terminal are restricted only by the imagination of those responsible for their design. In the near future, the mobile terminal will become an alternative form of resource storage, including storage for downloaded resources, acquired resources, locally created resources, and recreated resources, i.e., those resources created through the combination of other resource types.

Information exchange within the Internet is performed through the use of the HTTP, where an Internet Protocol (IP) address is provided to each network entity involved in the HTTP information transfer. Mobile terminals, however, are not addressed by an IP address, but are rather addressed by their Mobile Station Integrated Services Digital Network Number (MSISDN). Thus, direct transfer of information from the mobile terminal to users of the Internet via HTTP is virtually impossible.

Prior art methods of information exchange with mobile terminals require the use of a Personal Computer (PC) that is connected to the Internet. In such an instance, pictures and other information contained within the mobile terminal must first be transferred to the PC via a proximity connection such as infrared, Bluetooth, or conventional wired connections such as RS232 or RS485. Once transferred, the information must then be transferred to a Web server to enable storage and access via the Internet. Users of the Internet may then employ conventional HTTP methods to access the Web server to eventually upload the transferred information from the Web server. As such, mobile terminals today are incompatible with HTTP information exchange for several reasons.

### SUMMARY OF THE INVENTION

Techniques have recently been developed for implementing an information server, such as a Web server, in a mobile communication device or mobile terminal. Two of these recent techniques include, for example, those disclosed by U.S. patent application Ser. No. 10/611,647, entitled: System, Apparatus, and Method for Providing a Mobile Server, filed Jul. 1, 2003, and published Jan. 20, 2005, as U.S. Patent Application Publication No. 2005/0014489; and U.S. patent application Ser. No. 11/079,390, entitled: Information Server in a Communication System, filed Mar. 15, 2005, and published Jun. 22, 2006, as U.S. Patent Application Publication No. 2006/0136554, the content of both of which are hereby incorporated by reference in their entireties. A server implemented in a mobile terminal, i.e., a mobile server, may enable various new uses, such as immediate sharing of pictures taken by the user of the terminal and so on. In this context, a mobile server may be defined in other words as non-fixed or non-stationary server. And although recently developed techniques such as those identified above may provide advantages over conventional techniques, it is generally desirable to further improve upon existing techniques.

Consider, for example, that mobile terminals often store personal information of its owner (or user), and as such, it may be desirable for any information server implemented thereon to provide some manner of access control. However, providing access control to such an information server may be difficult, and may not even be possible with conventional off-the-shelf techniques used on traditional servers. In this regard, a straightforward approach where the information server handles access control may lead to problems such as requiring the transfer of all HTTP requests to the mobile terminal over a wireless connection, including those that are ultimately blocked; thereby possibly inducing undesirable cost to the terminal owner, particularly for those blocked requests. Requiring the information server to resolve numerous HTTP requests may also place an undesirable burden on limited power resources of the mobile terminal. In addition, providing access control at the information server may require the owner (or user) of the mobile terminal to perform the functions of an administrator for the creation and management of accounts for those clients authorized to access the HTTP server, and may also require the owner (as an administrator) to provide technical support to those clients. Further, from the standpoint of a client, providing access control at each information server independent of other such servers may undesirably require the client to maintain access parameters (e.g., username/password) for each server, which may become unwieldy as the number of such servers increases.

Exemplary embodiments of the present invention are therefore directed to an improved proxy gateway, mobile terminal, method and computer program product for providing access control for an information server implemented by a mobile terminal. Exemplary embodiments of the present invention are therefore directed to a framework for providing access control at a proxy gateway remote from the mobile terminal in a manner at least partially transparent to the web-server mobile terminal. The framework may therefore relieve the mobile terminal from fielding ultimately blocked requests over a possibly costly wireless connection. The framework may also relieve the owner of the mobile terminal from the burden of functioning as an administrator, instead placing that burden on the proxy gateway. And from the perspective of a client, the framework may permit a proxy gateway to service a plurality of information servers on one or more mobile terminals; thereby permitting the proxy gateway to manage access to those plurality of information servers via a reduced number of (if not the same) access parameters maintained by the client.

According to one aspect of the present invention, a system is presented for providing access control for an information server implemented by a mobile terminal. The system includes a proxy gateway configured for receiving a set of one or more control rules from the mobile terminal. The control rules define access rights to the information server for one or more clients, where each of one or more of the clients is identified in the rules by a telephone number associated therewith. In this regard, one or more of these telephone numbers may be recalled from a directory of contacts of an owner of the mobile terminal, the directory being stored by the mobile terminal.

The proxy gateway is also configured for receiving, from a client across a network (e.g., the Internet), a request to access a resource of the information server. In this regard, the request reflects a network address of the proxy gateway (e.g., a domain name of the proxy gateway), as well as an identity of the information server outside of the network (e.g., MSISDN of the mobile terminal). The proxy gateway is also configured for determining if the client is authorized to access the requested resource of the information server based upon a telephone number associated with the client and the set of control rules. In various instances, the client may comprise a device without a telephone number, and in such instances, the telephone number associated with the client may comprise a telephone number of another device of a user of the client. If the client is authorized, the proxy gateway is configured to send the request to the information server based upon the identity of the information server reflected in the request, and such that the information server sends a reply to the client via the proxy gateway. Otherwise, if the client is not authorized, the proxy gateway is configured for denying the request.

In accordance with exemplary embodiments of the present invention, the proxy gateway is configured for receiving (from the client) the telephone number associated with the client before receiving the request from the client. For example, the proxy gateway may be configured to set up an account for a user of the client before receiving the client's request, and during this setup procedure, the proxy gateway may receive a telephone number associated with the client. The proxy gateway may then be configured to identify the telephone number associated with the client based upon the respective account.

According to other aspects of the present invention, a proxy gateway, mobile terminal, method and computer program product are presented for providing access control for an information server implemented by a mobile terminal. Exemplary embodiments of the present invention therefore provide an improved gateway server, mobile terminal and method for providing access control for a mobile server in a communication system. And as indicated above and explained in greater detail below, the gateway server, mobile terminal and method of exemplary embodiments of the present invention may solve the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a terminal, gateway (GTW) and/or browser, in accordance with exemplary embodiments of the present invention;

FIG. 3 is a functional block diagram of a proxy GTW providing access control for an information resource implemented by a mobile terminal, in accordance with one exemplary embodiment of the present invention; and

FIG. 4 is a control flow diagram illustrating various steps in a method for providing access control for an information resource implemented by a mobile terminal, in accordance with exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

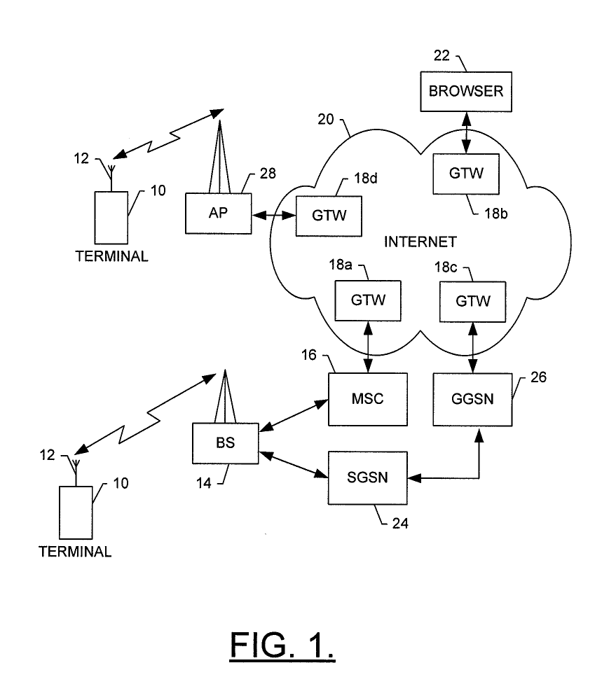

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, one or more terminals 10 may each include an antenna 12 for transmitting signals to and for receiving signals from a base site or base station (BS) 14. The base station is a part of one or more cellular or mobile networks each of which includes elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18a within a WAN, such as the Internet 20. In turn, devices such as processing elements (e.g., personal computers, server computers or the like) can be coupled to the terminal 10 via the Internet. For example, as explained below, the processing elements can include one or more processing elements associated with a computing system configured for accessing the Internet using HTTP requests, referred to herein as a browser 22 (one shown in FIG. 1) without loss of generality. Although these processing elements can be directly coupled to the Internet, similar to the MSC, in one typical embodiment the browser is coupled to a GTW 18b within the Internet. And although not shown in FIG. 1, in addition to or in lieu of coupling the terminal 10 to browser across the Internet 20, the terminal and browser can be coupled to one another and communicate in accordance with, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

The BS 14 can also be coupled to a signaling GPRS (General Packet Radio Service) support node (SGSN) 24. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network (not shown). The packet-switched core network is then coupled to another GTW, such as a GTW GPRS support node (GGSN) 26, and the GGSN is coupled to the Internet, such as directly or via a further GTW 18c. Also, the GGSN can be coupled to a messaging center. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 24 to the GPRS core network, GGSN 26 and GTW 18c, devices such as a browser 22 can be coupled to the terminal 10 via the Internet 20, SGSN, GGSN and GTW. In this regard, devices such as a browser can communicate with the terminal across the SGSN, GPRS, GGSN and GTW. By directly or indirectly connecting the terminals and the other devices (e.g., browser, etc.) to the Internet, the terminals can communicate with the other devices and with one another, such as according to the Hypertext Transfer Protocol (HTTP), to thereby carry out various functions of the terminal, such as in the manner explained below.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 28. The APs can comprise access points configured to communicate with the terminal in accordance with techniques such as, for example, RF, BT, IrDA or any of a number of different wireline or wireless communication techniques, including LAN, WLAN, WiMAX and/or UWB techniques. The APs may be coupled to the Internet 20. Like with the MSC 16, the APs can be directly coupled to the Internet. In one embodiment, however, the APs are indirectly coupled to the Internet via a GTW 18d. As will be appreciated, by directly or indirectly connecting the terminals and the browser 22 and/or any of a number of other devices, to the Internet, the terminals can communicate with one another, the browser, etc., to thereby carry out various functions of the terminal, such as to transmit data, content or the like to, and/or receive content, data or the like from, the browser. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

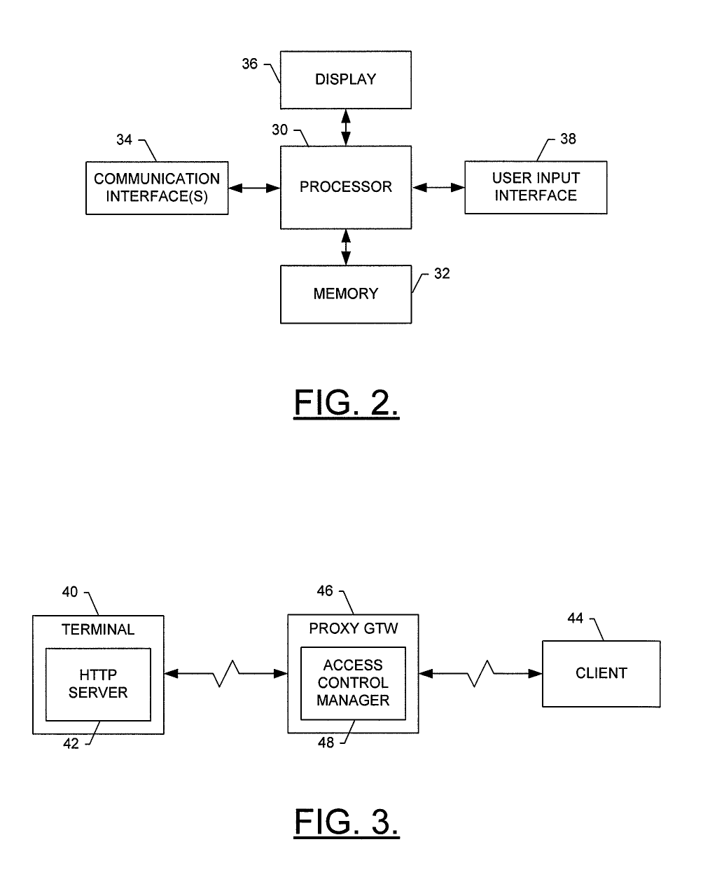

Referring now to FIG. 2, a block diagram of an entity capable of operating as a terminal 10, GTW 18 and/or browser 22 is shown in accordance with one embodiment of the present invention. Although shown as separate entities, in some embodiments, one or more entities may support one or more of a terminal, GTW and/or browser, logically separated but co-located within the entit(ies). For example, a single entity may support a logically separate, but co-located, GTW and computing. Also, for example, a single entity may support a logically separate, but co-located terminal and browser. Further, for example, a single entity may support a logically separate, but co-located terminal and GTW.

The entity capable of operating as a terminal 10, GTW 18 and/or browser 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 30 connected to a memory 32. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention.

As described herein, the client application(s) may each comprise software operated by the respective entity. It should be understood, however, that any one or more of the client applications described herein can alternatively comprise firmware or hardware, without departing from the spirit and scope of the present invention. Generally, then, the terminal 10, GTW 18 and/or browser 22 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., terminal, browser, etc.) or more particularly, for example, a processor 30 of the respective network entity. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 32, the processor 30 can also be connected to at least one interface or other means for displaying, transmitting and/or receiving data, content or the like. In this regard, the interface(s) can include at least one communication interface 34 or other means for transmitting and/or receiving data, content or the like. For example, the communication interface(s) can include a first communication interface for connecting to a first network, and a second communication interface for connecting to a second network. In addition to the communication interface(s), the interface(s) can also include at least one user interface that can include one or more earphones and/or speakers, a display 36, and/or a user input interface 38. The user input interface, in turn, can comprise any of a number of devices allowing the entity to receive data from a user, such as a microphone, a keypad, a touch display, a joystick, image capture device (e.g., digital camera) or other input device.

In accordance with exemplary embodiments of the present invention, a terminal 10 may implement an information resource, such as a Web server or Web services provider (WSP). An example of a service provided by an exemplifying WSP may comprise, but is not limited to, providing location information. A terminal configured to implement an information resource may be referred to as a web-server mobile terminal 40 for hosting an information resource, such as a Web server and/or a WSP (either or both being referred to herein as a HTTP server 42), as shown in FIG. 3. The web-server mobile terminal may implement a HTTP server in any of a number of different manners including, for example, in accordance with one or both of the aforementioned U.S. patent application Ser. Nos. 10/611,647 and 11/079,390. In accordance with the '647 application, for example, the web-server mobile terminal 40 may provide information resources and function as an HTTP server 42. Other devices functioning as HTTP clients 44 may comprise, for example, another terminal 10, a browser 22 or the like. The HTTP clients may access information provided by the web-server mobile terminal through the use of HTTP. The web-server mobile terminal may, for example, be used for publishing an information resource, such as a home page in wireless markup language (WML), hypertext markup language (HTML) or extensible hypertext markup language (XHTML), or image or video content, or the like.

As also shown in FIG. 3, for example, an HTTP request may be generated by a client 46 and delivered to the HTTP server 42 in the web-server mobile terminal 40. The request may pass though a proxy GTW 46 (e.g., any GTW 18 that may be functionally located between the client and the respective terminal) toward the HTTP server. The HTTP request may comprise a request line defining a method to be applied to the resource, the URI (Uniform Resource Identifier) of the resource and the protocol version used. The HTTP request may comprise further components, such as a general header having general applicability to request and response messages, a request header allowing a client to pass additional information about the request, an entity header defining meta-information about an entity body and a message body carrying the entity body associated with the request, and/or other further components.

An exemplary HTTP request line using a “GET” tag indicating the method to be applied to the resource according to the prior art may be as follows:
GET http://www.w3.org/pub/WWW/TheProject.html HTTP/1.1
   The exemplary request line includes the familiar URI pathname, “http://www.w3.org/pub/WWW/.” The file “TheProject.html” is to be retrieved from the URI as a result of the “GET” request. Mobile terminals, however, typically do not have an IP address or a URI associated with them; and therefore, may not be directly addressable within the Internet 20. Therefore, HTTP GET request-line as indicated above may not be compatible with the mobile terminal 40 for retrieving content therefrom.

In accordance with exemplary embodiments of the present invention, the proposed URI pathname used in an HTTP GET request from the client 44, for example, may take a form of “http://www.domain-name/identifier” or “http: identifier.domain-name.” The “identifier” portion of the URI pathname may reflect the identity of the web-server mobile terminal 40 to the proxy GTW 48 (the identity being recognized by the proxy GTW outside of the Internet 20), and the “domain-name” portion of the URI pathname may reflect the domain name of the proxy GTW in the network. The domain name, in turn, reflects an address (e.g., IP address) of the proxy GTW within the Internet. Thus, instead of reflecting the domain name of the proxy, the “domain-name” portion of the URI may directly reflect the address of the proxy GTW within the internet. The identifier portion of the URI, on the other hand, can be the mobile terminal owner's name, nick name, MSISDN or any other identifier which identifies the respective terminal to the proxy GTW.

After receiving the HTTP request, the proxy GTW 46 may proxy the request to the web-server mobile terminal 40 based upon the identity reflected by the identifier portion of the URI. Data access between the proxy GTW and the mobile terminal may be implemented in a number of different manners, particularly any of a number of different manners known to both the mobile terminal and proxy GTW. For example, data access may be implemented by tunneling the data between the mobile terminal and the proxy GTW using IP techniques, such as via the GPRS network. In other words, normal HTTP traffic may be tunneled between the mobile terminal and the proxy GTW. This tunneling may be effectuated with the mobile terminal registering or informing about itself to the proxy GTW, and setting-up the tunneling in order to be available to external devices.

In various instances it may be desirable to provide confidentiality and integrity for the communication between the mobile terminal 40 and proxy GTW 46. In such instances, as part of a registration or setting-up process, the mobile terminal may receive a private key assigned thereto, as well as a public key of the proxy GTW. These keys may thereafter be used for encrypting and/or authenticating communications between the mobile terminal and proxy GTW. Additionally or alternatively, the keys may be used to encrypt the time of the particular communications, a running number or some other value that may tie the communications back to a particular time and/or proxy GTW/mobile terminal. The keys may be received in a number of different manners, such as in a package from the proxy GTW where the package may be received directly from the proxy GTW or via a link from the proxy GTW. In this regard, the mobile terminal may be required to supply its telephone number to the proxy GTW during registration/setting up of the mobile terminal, following which the proxy GTW may provide the package/link to the supplied telephone number, such as in a Short Messaging Service (SMS) message.

Mobile terminals 10 often store personal information of its owner (or user), and as such, it may be desirable for any HTTP server 42 implemented thereon (i.e., a web-server mobile terminal 40) to provide some manner of access control. However, providing access control to a HTTP server implemented by a mobile terminal may be difficult, and may not even be possible with conventional off-the-shelf techniques used on traditional servers. In this regard, a straightforward approach where the HTTP server on the mobile terminal handles access control may lead to problems that can be categorized as “hard” problems involving cost; and “soft” problems involving usability, conceptual or from some other point of view. More particularly, providing access control at the HTTP server 42 may require transferring all HTTP requests to the mobile terminal 40 over a wireless connection, including those that are ultimately blocked; thereby possibly inducing undesirable cost to the terminal owner, particularly for those blocked requests. Also, requiring the HTTP server on the mobile terminal to resolve numerous HTTP requests may place an undesirable burden on limited power resources of the mobile terminal.

In addition, providing access control at the HTTP server 42 may require the owner (or user) of the mobile terminal 40 to perform the functions of an administrator for the creation and management of accounts for those clients 44 authorized to access the HTTP server, and may also require the owner (as an administrator) to provide technical support to those clients. And while such functions may be acceptable to technologically-savvy owners, those functions may not be acceptable or may otherwise be undesirable for other owners. Further, from the standpoint of a client, providing access control at each HTTP server independent of other such servers may undesirably require the client to maintain access parameters (e.g., username/password) for each server, which may become unwieldy as the number of such servers increases.

In view of the foregoing issues with providing access control at the HTTP server 42, exemplary embodiments of the present invention present a framework for providing access control at the proxy GTW 46 in a manner at least partially transparent to the web-server mobile terminal 40, where the proxy GTW may be configured to implement an access control manager 48 for providing such access control. The framework may therefore relieve the mobile terminal from fielding ultimately blocked HTTP requests over a possibly costly wireless connection. The framework of exemplary embodiments of the present invention may also relieve the owner of the mobile terminal from the burden of functioning as an administrator, instead placing that burden on the proxy GTW. And from the perspective of a client, the framework of exemplary embodiments of the present invention may permit a proxy GTW to service a plurality of HTTP servers on one or more mobile terminals; thereby permitting the proxy GTW to manage access to those plurality of HTTP servers via a reduced number of (if not the same) access parameters maintained by the client.

More particularly as to the framework of exemplary embodiments of the present invention, the HTTP server 42 of the web-server mobile terminal 40 may be configured to set (e.g., under direction of the mobile terminal owner) access rights control rules for one or more clients 44. To set such access rights control rules, however, may require the HTTP server to know the identities of those clients for which access rights control rules are set. In this regard, consider that mobile terminals typically store a list or directory including a number of telephone numbers (e.g., Mobile Station International ISDN Numbers—MSISDNs) of contacts of the owner of the mobile terminal. Thus, the web-server mobile terminal of exemplary embodiments of the present invention may identify clients according to telephone numbers associated with respective clients. This manner of identifying a client may even be provided in instances in which the client does not have a telephone number. In such instances, the associated telephone number may comprise the telephone number of another device of the owner (or user) of the respective client. Thus, for example, the telephone number associated with a browser 22 (i.e., client) may comprise the telephone number of a mobile terminal 10 of the user of the respective browser.

Similar to the HTTP server 42 of the web-server mobile terminal 40, the access control manager 48 of the proxy GTW may likewise be required to know the identities the clients 44 requesting access to the HTTP server. In principle, it may be possible to configure clients (e.g., mobile terminals 10) having telephone numbers to automatically provide those to the access control manager when requesting access to the HTTP server. In general, however, such a configuration may be problematic when the client does not have a telephone number (e.g., browser 22). Accordingly, in various exemplary embodiments of the present invention, a client desiring to access one or more HTTP servers serviced by a proxy GTW may register with the respective proxy GTW, such as in a manner transparent to the client user so that the registration appears as though it is originating with the HTTP proxy. During this registration process, the access control manager may request that the client (or client user registrant) provide a number of pieces of identifying information for setting up an account for the client user registrant. For example, the access control manager may be configured to send a selectable form or a form to be filled in, such as a HTML form, to the client for providing requested information. This requested/provided information included in the user account may include, for example, a username (and password, if required) (access parameters) and telephone number of the client or another device of the respective client user registrant. Upon registering with the proxy GTW, the client may be required to activate the user registration/account. In such instances, for example, the proxy GTW may send a message (e.g., SMS message) to the provided telephone number. This message may include a personal identification number (PIN), which may then be provided by the client user (or owner) back to the proxy GTW to activate the user registration/account.

The requested/provided information of the user account for a client 44 may therefore be utilized to identify a client requesting access to a HTTP server 42 of a web-server mobile terminal 40. In this regard, before requesting access to a HTTP server, the client may be required to login to the proxy GTW 46 servicing the respective HTTP server. During this login procedure, the access control manager 48 may request that the client provide the username (and password, if required) for the client user's account at the access control manager. And upon receipt of the username/password, the access control manager may identify a corresponding user account, including an associated telephone number included therein. This telephone number may then be considered the telephone number associated with the respective client for providing access control to a HTTP server serviced by the proxy GTW. It should be realized, however, that in lieu of registering/logging-in to the proxy GTW as explained above, the client may provide one or more of the above pieces of information in a number of other manners before gaining access to the HTTP server.

In accordance with exemplary embodiments of the present invention, the HTTP server 42 of the web-server mobile terminal 40 may be configured to set (e.g., under direction of the mobile terminal owner—or user) access rights control rules for one or more clients 44, identifying those clients by their associated telephone numbers. In this regard, the telephone numbers identifying one or more clients may be stored by the mobile terminal, such as in a list or directory of contacts of the owner of the mobile terminal. The HTTP server may be configured to receive access rights control rules for one or more clients from the mobile terminal owner, and send those rules to the access control manager 48 of the proxy GTW 46. For example, to allow access to persons Bob and Alice but deny access to everyone else, the HTTP server could send the access control manager the following access rights control rules:

Deny All

Allow Bob, Alice,

In the preceding example, in the access rights control rules sent to the access control manager, Bob and Alice may be identified by their respective telephone numbers, which may correspond to the telephone numbers in user accounts for Bob and Alice at the access control manager. Also in the preceding example, and in response to the access rights control rules, the access control manager may thereby be configured to first deny everybody access to the HTTP server, and then specifically permit access to Bob and Alice. That is, the access control manager may thereby be configured to filter out all traffic to the HTTP server except traffic from Bob and Alice, which have been specifically permitted.

Symmetrically, instead of filtering out all traffic except those specifically permitted access, the access control manager 48 could be configured to allow access to everybody, but specifically filter out certain clients 44. Consider, for example, the following access rights control rules:

Allow All

Deny Carol,

where again, Carol may be identified by her respective telephone number, which may correspond to the telephone number in a user account for Carol at the access control manager. In this example, the access control manager may be configured to allow all traffic to the HTTP server except from Carol, which may instead be filtered out.

It should further be noted that access rights control rules may permit more fine-tuned access control at the access control manager 48 of the proxy GTW 46. For example, in addition to filtering traffic by specific clients 44, traffic may be filtered by specific resources of the HTTP server 42, where those resources may be identified by Uniform Resource Locators (URLs). Consider, for example, the following access rights control rules:

Deny All

Allow Bob, Alice

Allow All/public

In this example, the access control manager is configured to deny access to everybody by default. The access control manager may permit Bob and Alice to access all resources of the respective HTTP server, however, and further permit everybody to access URLs including in the path “/public.” In this example, it should also be noted that the access control manager need not know the identity of a client 44 to permit access to URLs including in the path “/public,” and as such, exemplary embodiments of the present invention may further support anonymous access to resources of the HTTP server.

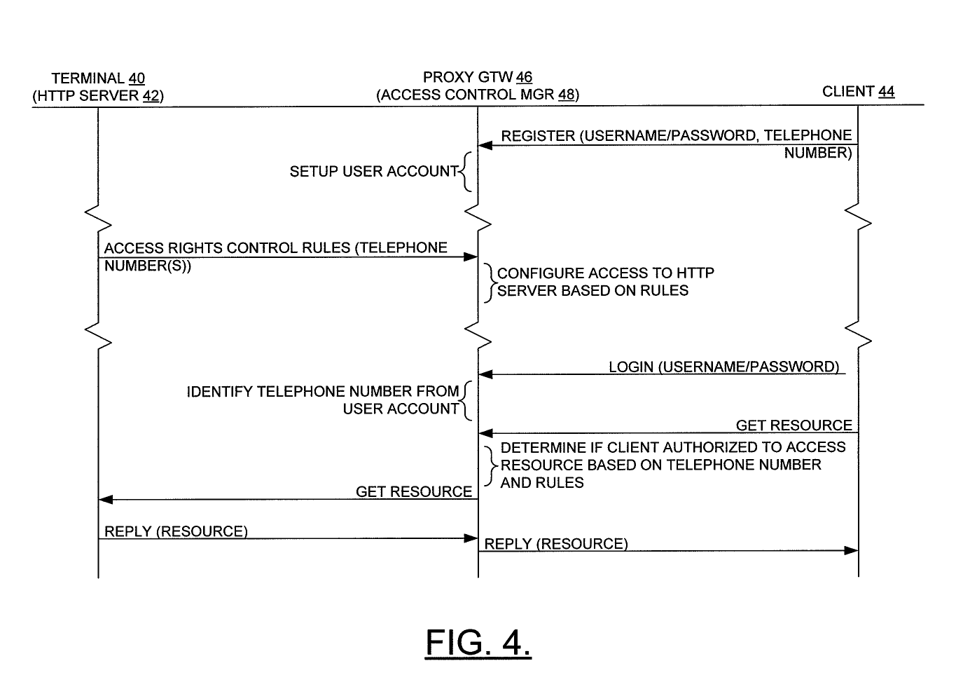

Reference is now made to FIG. 4, which illustrates a control flow diagram of a method for providing access control for the HTTP server 42 of a web-server mobile terminal 40 in accordance with exemplary embodiments of the present invention. As shown, the method includes a client 44 registering with or otherwise providing a number of pieces of information to a proxy GTW 46, or more particularly the access control manager 48 of a proxy GTW, servicing the HTTP server. As explained above, the information provided to the access control manager, such as during the registration process may include, for example, a username (and password, if required) and telephone number of the client or another device of the respective client user registrant. Then, after receiving the information from the client, the access control manager may setup a user account for the client user (or owner).

At some point before, after or as the client 44 provides its information to the access control manager 48 of the proxy GTW 46, the HTTP server 42 of the web-server mobile terminal 40 may set (e.g., under direction of the mobile terminal owner—or user) access rights control rules for one or more clients, identifying those clients by their associated telephone numbers. In this regard, the HTTP server may receive access rights control rules for one or more clients from the mobile terminal owner, and send those rules to the access control manager of the proxy GTW. The access control manager may thereafter configure access to the HTTP server based upon the access rights control rules and the telephone numbers associated therewith.

At one or more instances after providing its information to the access control manager 48 of the proxy GTW 46, and after the access control manager configures access to the HTTP server, the client may login to the proxy GTW. As explained above, during this login procedure, the access control manager 48 may request that the client provide the username (and password, if required) for the client user's account at the access control manager. And upon receipt of the username/password, the access control manager may identify a corresponding user account, including an associated telephone number included therein. This telephone number may then be considered the telephone number associated with the respective client for providing access control to a HTTP server serviced by the proxy GTW.

As the client 44 is logged in to the proxy GTW 46, the client may request a resource of the HTTP server 42 of the web-server mobile terminal 40, such as by sending an HTTP GET request to the HTTP server. As explained above, the URI in such resource requests reflects the domain name of the proxy GTW in the network, and as such, the resource request from the client is forwarded through respective network(s) to the proxy GTW. Upon receipt of the resource request, the proxy GTW may identify the web-server mobile terminal, or more particularly the HTTP server of the web-server mobile terminal, also from the URI in the resource request. From the identity of the HTTP server, the access control manager 48 of the proxy GTW may recall or otherwise identify the access rights control rules of the respective HTTP server. And from the telephone number associated with the client and the access rights control rules (including one or more telephone numbers), the access control manager may determine if the client is authorized to access the HTTP server (or the requested resource of the HTTP server).

If the client 44 is not authorized to access the HTTP server 42 (or the requested resource of the HTTP server), the access control manager 48 may deny the client's resource request, and may further notify the client that it is not authorized to access the requested HTTP server (or resource). Otherwise, if the client is authorized to access the HTTP server (or resource), as shown, the proxy GTW 46 may proxy or otherwise send the resource request to the HTTP server, such as by tunneling the resource request to the web-server mobile terminal, and thus the HTTP server. In response to the request, the HTTP server may send a reply including the requested resource (if appropriate) to the proxy GTW, such as by tunneling the reply to the proxy GTW. In turn, the proxy GTW may forward the reply to the client to fulfill the resource request.

According to one aspect of the present invention, the functions performed by one or more of the entities of the system, such as the web-server mobile terminal 40, proxy GTW 46 and/or client (e.g., terminal 10, browser 22, etc.) may be performed by various means, such as hardware and/or firmware, including those described above, alone and/or under control of a computer program product (e.g., HTTP server 42, access control manager 48, etc.). The computer program product for performing one or more functions of embodiments of the present invention includes a computer-readable storage medium, such as the non-volatile storage medium, and software including computer-readable program code portions, such as a series of computer instructions, embodied in the computer-readable storage medium.

In this regard, FIG. 4 is a control flow diagram of systems, methods and program products according to exemplary embodiments of the present invention. It will be understood that each block or step of the control flow diagram, and combinations of blocks in the control flow diagram, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the control flow diagram's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the control flow diagram's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the control flow diagram's block(s) or step(s).

Accordingly, blocks or steps of the control flow diagram supports combinations of means for performing the specified functions, combinations of steps for performing the specified functions and program instruction means for performing the specified functions. It will also be understood that one or more blocks or steps of the control flow diagram, and combinations of blocks or steps in the control flow diagram, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A proxy gateway for providing access control for an information server implemented by a mobile terminal, the proxy gateway comprising:
a processor configured for receiving a set of one or more control rules defining access rights to the information server of the mobile terminal located remote from the proxy gateway, the access rights being defined for one or more clients, each of one or more of the clients being identified in the rules by a telephone number associated therewith,
wherein the processor is configured for receiving, from a client across a network, a request to access a resource of the information server, the request reflecting a network address of the proxy gateway, and reflecting an identity of the information server outside of the network,
wherein the processor is configured for determining if the client is authorized to access the requested resource of the information server based upon a telephone number associated with the client and the set of control rules, the telephone number associated with the client having been received from the client before receiving the request, and
wherein the processor is configured for (a) sending the request to the information server if the client is authorized, the request being sent based upon the identity of the information server reflected in the request, and such that the information server sends a reply to the client via the proxy gateway; or otherwise, (b) denying the request if the client is not authorized.

2. A proxy gateway according to claim 1, wherein a user of the client has an account at the proxy gateway that includes the telephone number associated with the client, and wherein the processor is further configured for identifying the telephone number associated with the client based upon the respective account, the telephone number being identified before determining if the client is authorized.

3. A proxy gateway according to claim 2, wherein the processor is further configured for setting up an account for a user of the client before receiving the request, the processor being configured to set up the account including receiving, from the client, a telephone number associated with the client.

4. A proxy gateway according to claim 1, wherein the processor is configured for receiving one or more control rules identifying each of one or more clients by a telephone number stored by the mobile terminal in a directory of contacts of an owner of the mobile terminal.

5. A proxy gateway according to claim 1, wherein the client comprises a device without a telephone number, and wherein the processor is further configured for identifying the telephone number associated with the client before determining if the client is authorized, the telephone number comprising a telephone number of another device of a user of the client.

6. A proxy gateway for providing access control for an information server implemented by a mobile terminal, the proxy gateway comprising:
a first means for receiving, at the proxy gateway located remote from the mobile terminal, a set of one or more control rules defining access rights to the information server, the access rights being defined for one or more clients, each of one or more of the clients being identified in the rules by a telephone number associated therewith;
a second means for receiving, at the proxy gateway from a client across a network, a request to access a resource of the information server, the request reflecting a network address of the proxy gateway, and reflecting an identity of the information server outside of the network;
a third means for determining if the client is authorized to access the requested resource of the information server based upon a telephone number associated with the client and the set of control rules, the telephone number associated with the client having been received from the client before receiving the request; and
a fourth means for (a) sending the request to the information server if the client is authorized, the request being sent based upon the identity of the information server reflected in the request, and such that the information server sends a reply to the client via the proxy gateway; or otherwise, (b) denying the request if the client is not authorized.

7. A proxy gateway according to claim 6, wherein a user of the client has an account at the proxy gateway that includes the telephone number associated with the client, and wherein the computer-readable program code portions further comprise a fifth means for identifying the telephone number associated with the client based upon the respective account, the telephone number being identified before determining if the client is authorized.

8. A proxy gateway according to claim 7, wherein the computer-readable program code portions further comprise a sixth means for setting up an account for a user of the client before receiving the request, setting up the account including receiving, at the proxy gateway from the client, a telephone number associated with the client.

9. A proxy gateway according to claim 6, wherein the first means is adapted for receiving one or more control rules identifying each of one or more clients by a telephone number stored by the mobile terminal in a directory of contacts of an owner of the mobile terminal.

10. A proxy gateway according to claim 6, wherein the client comprises a device without a telephone number, and wherein the computer-readable program code portions further comprise a fifth means for identifying the telephone number associated with the client before determining if the client is authorized, the telephone number comprising a telephone number of another device of a user of the client.

11. A mobile terminal for implementing an information server, the mobile terminal comprising:
a processor configured for sending, to a proxy gateway located remote from the mobile terminal, a set of one or more control rules defining access rights to the information server, the access rights being defined for one or more clients, each of one or more of the clients being identified in the rules by a telephone number associated therewith,
wherein the proxy gateway is configured for receiving, from a client across a network, a request to access a resource of the information server, the request reflecting a network address of the proxy gateway, and reflecting an identity of the information server outside of the network,
wherein the proxy gateway is configured for determining if the client is authorized to access the requested resource of the information server based upon a telephone number associated with the client and the set of control rules, the telephone number associated with the client having been received from the client before receiving the request,
wherein the processor is configured for receiving the request from the proxy gateway if the client is authorized, the request being received based upon the identity of the information server reflected in the request, the request otherwise being denied by the proxy gateway if the client is not authorized, and
wherein the processor is configured for sending a reply to the client via the proxy gateway when the processor receives the request.

12. A mobile terminal according to claim 11, wherein the processor is configured for sending one or more control rules identifying each of one or more clients by a telephone number stored by the mobile terminal in a directory of contacts of an owner of the mobile terminal.

13. A method for providing access control for an information server implemented by a mobile terminal, the method comprising:
receiving, at a proxy gateway located remote from the mobile terminal, a set of one or more control rules defining access rights to the information server, the access rights being defined for one or more clients, each of one or more of the clients being identified in the rules by a telephone number associated therewith;
receiving, at the proxy gateway from a client across a network, a request to access a resource of the information server, the request reflecting a network address of the proxy gateway, and reflecting an identity of the information server outside of the network;
determining if the client is authorized to access the requested resource of the information server based upon a telephone number associated with the client and the set of control rules, the telephone number associated with the client having been received from the client before receiving the request; and
(a) sending the request to the information server if the client is authorized, the request being sent based upon the identity of the information server reflected in the request, and such that the information server sends a reply to the client via the proxy gateway; or otherwise, (b) denying the request if the client is not authorized,
wherein the determining, and sending or denying steps are performed at the proxy gateway.

14. A method according to claim 13, wherein a user of the client has an account at the proxy gateway that includes the telephone number associated with the client, and wherein the method further comprises identifying the telephone number associated with the client based upon the respective account, the telephone number being identified before determining if the client is authorized.

15. A method according to claim 14 further comprising setting up an account for a user of the client before receiving the request, setting up the account including receiving, at the proxy gateway from the client, a telephone number associated with the client.

16. A method according to claim 13, wherein the receiving a set of one or more control rules comprises receiving one or more control rules identifying each of one or more clients by a telephone number stored by the mobile terminal in a directory of contacts of an owner of the mobile terminal.

17. A method according to claim 13, wherein the client comprises a device without a telephone number, and wherein the method further comprises identifying the telephone number associated with the client before determining if the client is authorized, the telephone number comprising a telephone number of another device of a user of the client.

18. A computer program product for providing access control for an information server implemented by a mobile terminal, the computer program product comprising at least one computer-readable storage medium of a proxy gateway located remote from the mobile terminal, the computer-readable storage medium having computer-readable program code portions stored therein, the computer-readable program code portions comprising:
a first executable portion for receiving, at the proxy gateway located remote from the mobile terminal, a set of one or more control rules defining access rights to the information server, the access rights being defined for one or more clients, each of one or more of the clients being identified in the rules by a telephone number associated therewith;
a second executable portion for receiving, at the proxy gateway from a client across a network, a request to access a resource of the information server, the request reflecting a network address of the proxy gateway, and reflecting an identity of the information server outside of the network;
a third executable portion for determining if the client is authorized to access the requested resource of the information server based upon a telephone number associated with the client and the set of control rules, the telephone number associated with the client having been received from the client before receiving the request; and
a fourth executable portion for (a) sending the request to the information server if the client is authorized, the request being sent based upon the identity of the information server reflected in the request, and such that the information server sends a reply to the client via the proxy gateway; or otherwise, (b) denying the request if the client is not authorized.

19. A computer program product according to claim 18, wherein a user of the client has an account at the proxy gateway that includes the telephone number associated with the client, and wherein the computer-readable program code portions further comprise a fifth executable portion for identifying the telephone number associated with the client based upon the respective account, the telephone number being identified before determining if the client is authorized.

20. A computer program product according to claim 19, wherein the computer-readable program code portions further comprise a sixth executable portion for setting up an account for a user of the client before receiving the request, setting up the account including receiving, at the proxy gateway from the client, a telephone number associated with the client.

21. A computer program product according to claim 18, wherein the first executable portion is adapted for receiving one or more control rules identifying each of one or more clients by a telephone number stored by the mobile terminal in a directory of contacts of an owner of the mobile terminal.

22. A computer program product according to claim 18, wherein the client comprises a device without a telephone number, and wherein the computer-readable program code portions further comprise a fifth executable portion for identifying the telephone number associated with the client before determining if the client is authorized, the telephone number comprising a telephone number of another device of a user of the client.
